(19) United States
(12) Patent Application Publication
(10) Pub. No.: US 2011/0119117 A1
(43) Pub. Date: May 19, 2011

(54) GENERATION OF PRODUCTS IN CATALOGS FROM DIVERGENT LISTINGS

(76) Inventors: Brian Yu, Redwood City, CA (US); Guilherme Bastos, Sunnyvale, CA (US)

(21) Appl. No.: 12/619,494

(22) Filed: Nov. 16, 2009

(51) Int. Cl. G06Q 30/00; G06Q 10/00; G06F 17/30

(52) U.S. Cl. 705/12; 705/343; 707/769; 707/E17.014; 705/26.1

(57) ABSTRACT

Methods and systems to generate product records in catalogs from divergent listings are provided. Example systems include a listings module to identify an immature product record corresponding to the item for sale. The listings module may determine, from one or more attributes of an item for sale described by the listing, that the item can be matched to an immature product record. A voting module may provide an interface including the first version of the immature product record and an option to select a first version or a second version of the immature product record matching the item. The voting module may further relate the selected version to the item for sale based on a selection by a user, and, in response, update a count of votes for the selected version. When the count of votes meets a threshold, the selected version may become the mature product record for inclusion in a catalog.

### TECHNICAL FIELD

The present application relates generally to the technical field of data processing and, in one specific example, to the generation of products in catalogs for divergent listings.

### BACKGROUND

An online publishing system may receive listings from multiple users where each listing describes an item to be sold. The listings themselves may range from detailed and complete to sparse and incomplete. When many listings have been received, it may be difficult for a potential buyer or other sellers to navigate through and search for relevant listings. While some organization may be provided within the online publishing system, it may be limited to listings that are detailed and complete.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed.

FIG. 2 is a block diagram depicting catalog engines that, in one embodiment, are provided as part of the described systems.

FIG. 3 is a flowchart of an exemplary process for making a determination to create a new immature product, according to various embodiments.

FIG. 4 is a flowchart of an exemplary process for making a determination that a listing is mature.

FIG. 5 is a high-level entity-relationship diagram, illustrating various tables that may be maintained within databases.

FIG. 6 provides further details regarding product tables and catalog tables that are shown in FIG. 5 and which are to be maintained within databases.

FIG. 7 shows a diagrammatic representation of a machine in the example form of a computer system within which a set of instructions, for causing the machine to perform any one or more of the methodologies discussed herein, may be executed.

### DETAILED DESCRIPTION

Example methods and systems to generate product data (e.g., product records) for products in catalogs from divergent item data (e.g., item records or listings) are described. In the following description, for purposes of explanation, numerous specific details are set forth in order to provide a thorough understanding of example embodiments. It will be evident, however, to one skilled in the art that embodiments of the present invention may be practiced without these specific details.

Item data, in the example form of divergent listings, is received from users in an online publication system. Each listing of the divergent listings describes a sale item (i.e., an item for sale) that may correspond to other, nearly identical, sale items. Item descriptions of the item listings may be of varying degrees of completeness and may include separate descriptions, pictures, specifications, titles, and so forth. When a number of identical items are offered within the online publication system, the item descriptions may be aggregated into a product description. Each product can may include a title, description, pictures, specifications, etc., that have been collected from the divergent listings and/or from additional sources.

To illustrate, before generating a “Blue iPod 20 GB” product, multiple users may submit listings of items that are each a “Blue iPod 20 GB.” These listings, however, are likely to be divergent in that they may include different pictures, descriptions, and/or have different titles by virtue of having been submitted by different users. Information in these divergent listings, or portions of the divergent listings, may be used to identify that the listing may be a “Blue iPod 20 GB.” To populate a “Blue iPod 20 GB” product, the information contained within the divergent listings may be aggregated into the “Blue iPod 20 G” product that is associated with each of the items in the divergent listings.

When a product record is initially generated, the product may be designated as “immature,” meaning that it is still missing information and/or that it is still modifiable by users. Immature product records may be inventoried and/or may be included as search results in the online publication system. It should be noted that there may be more than one version of an immature product record. The methods described herein include a voting system that allows users who are adding new listings to vote on one or more existing descriptions of a product record. When a threshold number of users each select the same description to associate with their listing, the product record may be considered a mature product record that can be included, for example, in a catalog or other, more sophisticated features of the online publication system.

In some instances, more experienced users may be allowed to give weightier feedback as to whether the product record (that provides a product definition) is mature. Further, even a mature product record may be editable in certain instances. Other embodiments may include auto tagging divergent listings prior to corresponding them to a product record candidate or an immature product record. The product records described herein may be used prior to maturity to, for example, determine inventory level, determine demand for an item, and/or be used to compare one product record to another.

### Platform Architecture

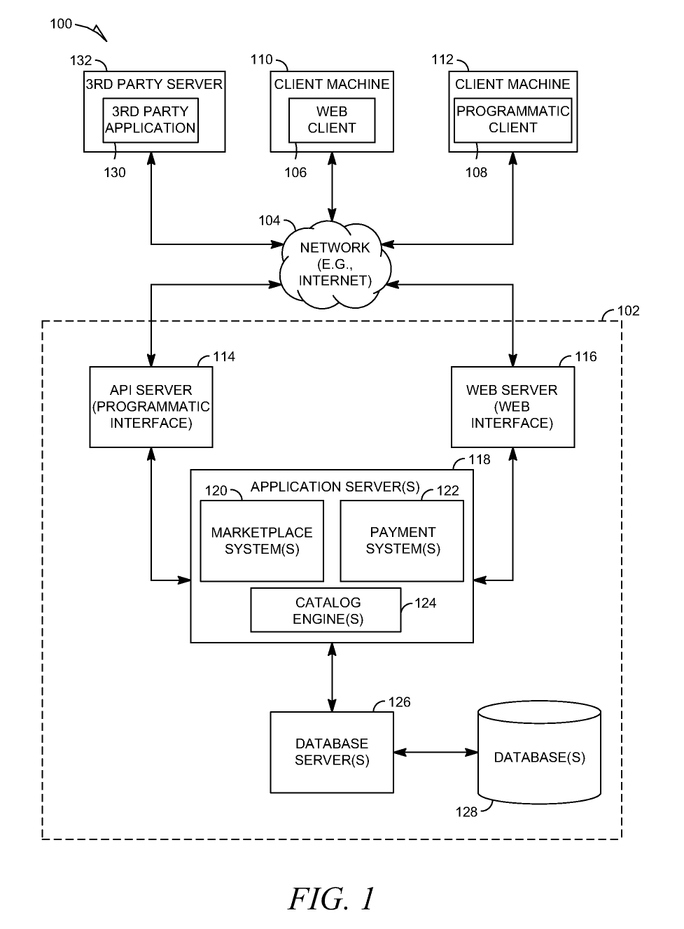

FIG. 1 is a network diagram depicting a client-server system 100, within which one example embodiment may be deployed. A networked system 102, in the example form of a network-based marketplace or publication system, provides server-side functionality, via a network 104 (e.g., the Internet or Wide Area Network (WAN)) to one or more clients. FIG. 1 illustrates, for example, a web client 106 (e.g., a browser, such as the Internet Explorer browser developed by Microsoft Corporation of Redmond, Wash. State), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace systems 120, payment systems 122, and catalog engines 124. The application servers 118 are, in turn, shown to be coupled to one or more databases servers 126 that facilitate access to one or more databases 128.

The marketplace systems 120 may provide a number of marketplace functions and services to users that access the networked system 102. The payment systems 122 may likewise provide a number of payment services and functions to users. The payment systems 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace systems 120. While the marketplace and payment systems 120 and 122 are shown in FIG. 1 to both form part of the networked system 102, it will be appreciated that, in alternative embodiments, the payment systems 122 may form part of a payment service that is separate and distinct from the networked system 102.

Catalog engines 124 may be used to associate a listing to a product record and/or to direct a potential buyer to one or more listings that correspond to a desired product record. The catalog engines 124 may generate and maintain one or more catalogs that may each be associated with a specific product domain. Examples of product domains may include, for example, electronics, apparel, jewelry, toys, automotive, and so forth. The catalogs may be organized, for example, in a hierarchy, table structure, or other data structure known to those skilled in the art.

The catalog engines 124 may receive divergent listings from multiple users and determine whether to catalog at least a portion of the divergent listings corresponding to a single product record. The catalog engines 124 may determine whether an appropriate catalog and/or product record (either an immature product record or a mature product record) already exists or if a new catalog and/or product record should be created for one or more of the divergent listings. Where an appropriate product record already exists, one or more of the listings may be mapped to (or otherwise associated with) the product record. However, if the product record is not already included in the catalog, the catalog engines 124 may operate to add the product record (and the listing) to the catalog. While the catalog engines 124 are more generally involved in generating catalogs from divergent listings, the catalog engines 124 may further operate to generate mature product records for inclusion in a catalog.

Further, while the client-server system 100 shown in FIG. 1 employs a client-server architecture, embodiments are, of course, not limited to such an architecture, and could equally well find application in a distributed, or peer-to-peer, architecture system, for example. The various marketplace and payment systems 120 and 122 and the catalog engines 124 could also be implemented as standalone software programs, which do not necessarily have networking capabilities.

The web client 106 accesses the various marketplace and payment systems 120 and 122 via the web interface supported by the web server 116. Similarly, the programmatic client 108 accesses the various services and functions provided by the marketplace and payment systems 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 130, executing on a third party server machine 132, as having programmatic access to the networked system 102 via the programmatic interface provided by the API server 114. For example, the third party application 130 may, utilizing information retrieved from the networked system 102, support one or more features or functions on a website hosted by the third party. The third party website may, for example, provide one or more promotional, marketplace or payment functions that are supported by the relevant applications of the networked system 102.

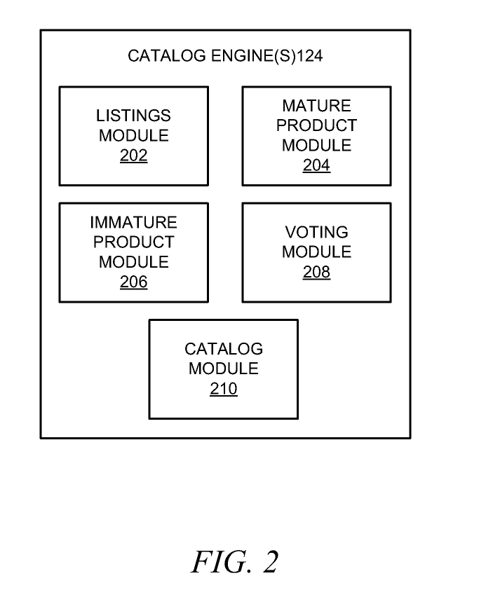

FIG. 2 is a block diagram depicting the catalog engines 124 that, in various embodiments, are provided as part of the marketplace systems 120. The catalog engines 124 comprise, for example, a listings module 202, a mature product module 204, an immature product module 206, a voting module 208, and a catalog module 210. It is noted that, to generate catalogs using the product records, the catalog engines 124 may include additional modules to perform those functions.

The listings module 202 receives the divergent listings from one or more users and parses or scrapes portions of the listings. The listings module 202 may send the portions to one or more additional modules to collect data or metadata from each of the listings based on keywords, attributes, and/or the user history associated with the user from whom the listing was received.

The mature product module 204 stores and accesses product record descriptions that have been designated as “completed” or “mature.” The mature product record descriptions are generally complete and include, for example, images, specifications, a description, and a title. Generally, completed product records have received a requisite number or percentage of votes and are no longer editable or changeable by users. The mature product module 204 may access and maintain one or more tables that associate each product record with one or more listings. In some instances, the mature product module 204 receives additional listings to associate with a product record. In some instances, the mature product module 204 determines whether to remove a product record. For example, a product record may be removed if there are no associated listings or if a period of time has elapsed since an item associated with the product record has been posted or sold. The mature product module 204 may be accessed by a catalog module 210 and/or by other modules.

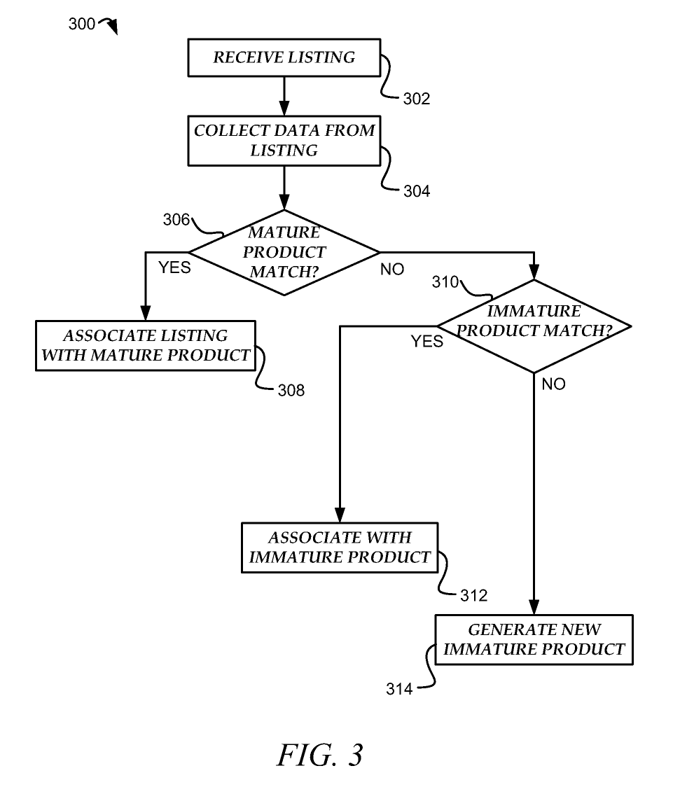

The immature product module 206 generates, stores, and/or accesses product record descriptions that are not yet mature. The immature product module 206 contains or has access to versions of descriptions associated with each immature product record. The versions of the immature product records may each include pictures, descriptions, titles, and/or images of the items being sold. In some instances, the immature product module 206 may receive a cluster of listings from the listings module 202 that are likely to describe a single product record. In one embodiment, the immature product module 206 may perform certain statistical functions on a plurality of listings received from the information received from the listings module 202 as described in connection with FIG. 3. The immature product module 206 may maintain more than one description associated with each product record. Each description may be received from a single user and/or an assembled description generated or aggregated from more than one the list of the listings. In some instances, a user may provide the assembled description.

The voting module 208 operates a voting system for determining whether a product record is mature. The voting module 208 accesses one or more immature product record descriptions from the immature product module 206 and presents them to a user who has identified the product record as corresponding to a listing provided by the user. The voting module 208 provides a voting interface where the user is able to select one of the available versions of the product record. Based on the number of selections of a particular version and/or votes received by the voting module 208, a product record may be designated as mature.

In some instances, the voting module 208 compares the number of votes for a particular product record description to a threshold. The threshold may be user defined, heuristics-based, weighted, domain-based, or the like. A user may vote for the particular version of the product record by selecting the version to be associated with the listing instead of generating a new listing.

In some instances, the user's vote may be weighted relative to the votes of other users. In these instances, the user's vote may, for example, be multiplied by a factor associated with the user so that the user's vote “counts” as two, three, four, or more votes towards a threshold. The determination to weight a vote of a particular user may be based on data about the user or the user's previous activities within the online publication system. For example, a user's vote may be given more weight if the user has sold similar items before, has more than one item corresponding to the product for sale, and/or has a good reputation based on past sales. In some embodiments, the user's vote may be weighted if the user has authored other mature product records and/or has previously voted for a version of an immature product record that ultimately became the mature product record.

In some instances, users may vote for more than one version of the product record by ranking the versions. The relative ranking of each version may determine the weight of the user's vote for that particular product record. In other embodiments, the user may only vote for one version. Users may or may not be able to cancel a former vote and resubmit a new vote for another version of the product record. In some instances, a user may be notified if a new version of the immature product record is generated by another user to allow a user to “change” his or her vote to the newer version.

To receive the votes, the voting module 208 may provide a voting interface to the user. The voting interface may include one or more previously generated product record versions that are currently immature, an interface to generate the new product record description that may or may not be based on an earlier product record description, and/or a wiki interface for receiving edits from more than one user. The voting module 208 may communicate new versions of the immature product record to the immature product module 206. When a product record is mature, the voting module 208 may communicate the winning version of the product record to the mature product module 204 and may or may not delete the remaining versions of the immature product record.

The catalog module 210 produces one or more catalogs based on the mature product records and/or the immature product records. The catalog module 210 operates to generate and/or modify one or more catalogs based on the mature product records stored in the mature product module 204 and a determination of whether to catalog the product records. In instances where the catalog includes immature product records, the immature product records may be access limited. For example, the immature product records may only be shown to user in response to a search or query. In other embodiments, the immature product records may only be accessed by an administrator. The catalog module 210 may have access to only one version of the immature product record that may be, for example, a first version of the product record received from a user. When a version of the immature product record is designated as the mature product record, the mature product record may replace the first version in the catalog module 210.

FIG. 3 is a flowchart of an exemplary process 300 for making a determination to create new immature product data (e.g., a product record), according to various embodiments. In some instances, the process 300 may be performed when a listing indicating a sale item is received from a user and may result in a new immature product record that can later be associated with multiple product record versions and/or be voted on by other users. The process 300 may be performed by the listings module 202 in communication with the mature product module 204 and the immature product module 206.

In an operation 302, a listing indicating an item to be sold is received from a user. In an operation 304, data is collected from the listing. Operations 302 and 304 may be performed by the listings module 202. In some instances, the listing may comprise data such as a bar code, an International Standard Book Number (ISBN), a short description or title, attribute values, or the like. In some instances, the data collected from the listing may not form a complete description of the product.

In an operation 306, a determination is made whether the item in the listing matches a mature product record within the mature product module 204. The determination may or may not be confirmed by the user via an interface indicating the mature product record and an option to reject the proposed match between the listing and the mature product record. In some instances, the interface may indicate more than one mature product record with which the item may be matched and include an option to select one of the mature product records.

If the sale item matches a mature product record, the listing is associated with the mature product record in an operation 308. This association may link the listing directly to a product record and/or cause an additional interface to be generated via which the user may provide item-specific information such as condition, price, return policy, and the like.

If, however, no mature product record match is determined or if the user rejects one or more proposed matches, a second determination is made that the item matches an immature product record in an operation 310. The immature product record match may correspond to more than one version of the matching immature product record. Because immature product records may be incomplete, additional information may be culled from the user or the listing to further populate the product record versions such as specifications and attribute values.

If the immature product record does match an existing immature product record, the listing is associated with the immature product record in an operation 312. If, however, the listing does not match an immature product record, the listing may be used to generate a new immature product record in an operation 314.

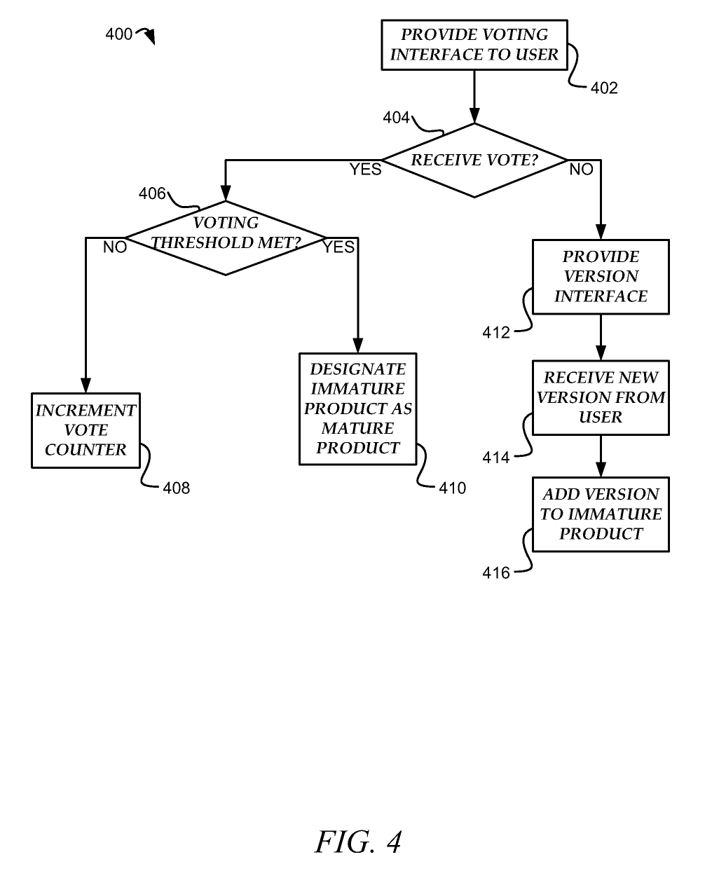

FIG. 4 is a flowchart of an exemplary process 400 for making a determination that a listing is mature. The process 400 may be performed by the catalog engines 124 and, in particular embodiments, by the voting module 208. The process 400 may be performed after the process 300 to permit the user to vote for a particular version of an immature product record following operation 312. In some instances, as will be apparent, portions of the process 400 may be performed following operation 314 to generate a first version of an immature product record.

In an operation 402, a voting interface is provided to the user. The voting interface may include one or more versions of an immature product record. In some instances, only a portion of the version of the immature product record may be provided in the interface depending, for example, on recently received votes, user characteristics, and/or relative completeness of the versions of the immature product record. The voting interface may or may not include an option to generate a new version of the immature product record.

In an operation 404, a determination is made whether a vote has been received from the user. If a vote has been received from the user indicating a selection of at least one of the versions of the immature product record to be associated with the item for sale by the user, a second determination whether the voting threshold has been met is made in operation 406. The second determination may include, for example, determining a weight to assign to the vote, as discussed above with respect to the voting module 208. The voting threshold may be a minimum number of votes, a percentage of votes (e.g., 60% of votes after a certain number of total votes are received), a minimum lead over the number of votes of the next popular version (e.g., the version leads other versions by at least five votes), or some combination thereof.

In an operation 408, if the voting threshold is not met, the vote counter (or other counting mechanism) is incremented to reflect the received vote. In some instances, the counter may be displayed to other users to track the popularity of various versions of the immature product records. If the voting threshold is met, the winning version of the immature product record is designated as the mature product record in an operation 410. The mature product record may then be included in one or more catalogs and/or may not be modified by subsequent users. The mature product record may include one or more images, a complete or nearly complete set of specifications and attributes, a searchable title, and the like.

If, in operation 404, a determination that no vote was received is made, a version interface may be provided to the user in an operation 412. No vote may be received in a variety of circumstances. For example, no vote may be received if the user does not affirmatively vote for any of the existing versions of the immature product record or if there are no versions of the product record available. In some instances, no vote may be received if the user indicates that there are no product records (either mature product records or immature product records) that match the sale item by the user.

The version interface may include an option to select another version of the immature product record to edit, an option to select a mature product record or immature product record that is similar to the sale item, and/or an option to generate a new version without relying on any previous versions. In some embodiments, a wiki interface may be provided. A wiki interface may be desirable for product records that have a number of attributes that are not particular to a single item. For example, attributes for a digital camera may include optical zoom, resolution, dimensions, battery information, memory card data, screen size, and the like.

The user may create a new version of the immature product record by editing an existing version and/or generating a new version without relying on an existing version. The new version is received from the user in an operation 414 and added to the immature product record in an operation 416.

### Data Structures

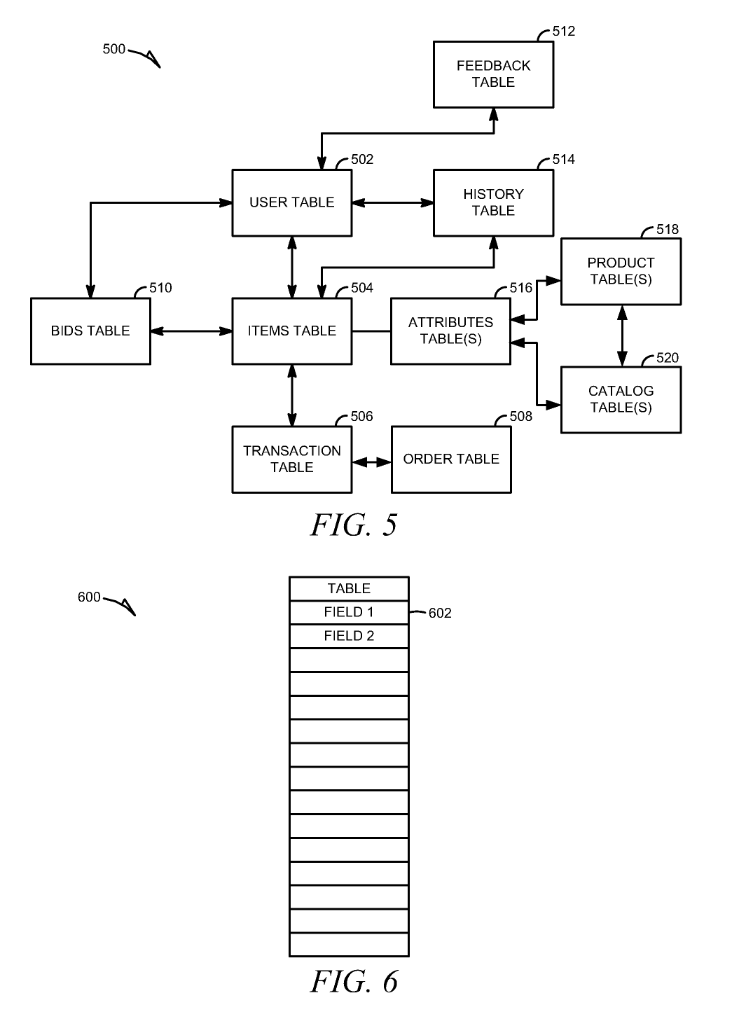

FIG. 5 is a high-level entity-relationship diagram, illustrating various tables 500 that may be maintained within the databases 128, and that are utilized by and support the systems 120 and 122. A user table 502 contains a record for each registered user of the networked system 102, and may include an identifier and address and financial instrument information pertaining to each such registered user. A user may operate as a seller, a buyer, or both, within the networked system 102. In one example embodiment, a buyer may be a user that has accumulated value (e.g., commercial or proprietary currency), and is accordingly able to exchange the accumulated value for items that are offered for sale by the networked system 102.

The tables 500 also include an items table 504 in which are maintained item records for goods and services that are available to be, or have been, transacted via the networked system 102. Each item record within the items table 504 may furthermore be linked to one or more user records within the user table 502, so as to associate a seller and one or more actual or potential buyers with each item record.

A transaction table 506 contains a record for each transaction (e.g., a purchase or sale transaction) pertaining to items for which records exist within the items table 504.

An order table 508 is populated with order records, each order record being associated with an order. Each order, in turn, may be recorded with respect to one or more transactions for which records exist within the transaction table 506.

Bid records within a bids table 510 each relate to a bid received at the networked system 102 in connection with an auction-format listing. A feedback table 512 is utilized, in one example embodiment, to construct and maintain reputation information concerning users. A history table 514 maintains a history of transactions to which a user has been a party. One or more attributes tables 516 record attribute information pertaining to items for which records exist within the items table 504. Considering only a single example of such an attribute, the attributes tables 516 may indicate a currency attribute associated with a particular item, the currency attribute identifying the currency of a price for the relevant item as specified in by a seller.

Product tables 518 each relate one or more product records with one or more attributes of those product records and one or more catalogs. The product tables 518 may include product tables of mature product records and/or product tables of immature product records. The product tables for immature product records may additionally include tables for each version of the immature product record. The catalog tables 520 may each relate the product records and/or the attributes to the catalogs.

FIG. 6 provides further details regarding product tables 518 and the catalog tables 520 to be maintained within the databases 126. The product tables 518 (e.g., table 600) may each store data about each product record that has been identified in the catalog. For example, each field (e.g., field 602) may store a value corresponding to an attribute of the product record. Each table (e.g., table 600) of catalog tables 520 may store product record identifiers associated with a catalog in the fields (e.g., fields 602).

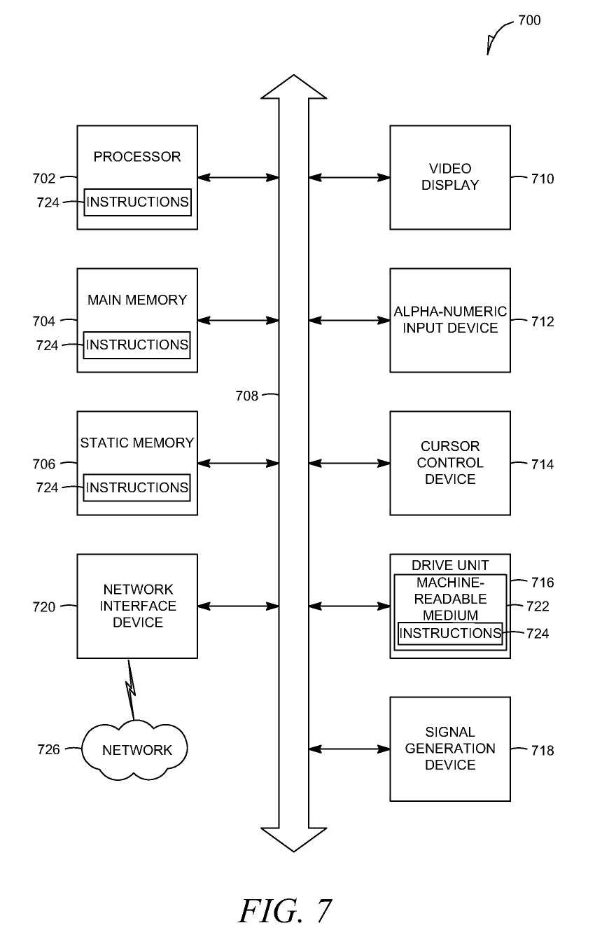

FIG. 7 shows a diagrammatic representation of a machine in the example form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU) a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies or functions described herein. The software 724 may also reside, completely or at least partially, within the main memory 704 and/or within the processor 702 during execution thereof by the computer system 700, the main memory 704 and the processor 702 also constituting machine-readable media.

The software 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the disclosed embodiments. The term “machine-readable medium” shall accordingly be taken to include, but not be limited to, solid-state memories, and optical and magnetic media.

Certain embodiments are described herein as including logic or a number of components, modules, or mechanisms. Modules may constitute either software modules (e.g., code embodied on a machine-readable medium or in a transmission signal) or hardware modules. A hardware module may be a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software), may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to generate mature products for a catalog have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An online publication system comprising:
a hardware-implemented listings module to receive item data relating to a sale item, determine an attribute of the sale item using the item data, and based on the attributes, to identify a product record within a database corresponding to the sale item;
a hardware-implemented product module to store at least a first version and a second version of the product record; and
a hardware-implemented voting module to provide an interface including the first version of the product record and an option to select the first version or the second version, to relate the selected version to the sale item, and to update a count of votes for the selected version.

2. The online publication system of claim 1, wherein the voting module is further to determine that the count of votes meets a threshold and to designate the selected version of the product record as a mature product record.

3. The online publication system of claim 2, further comprising a hardware-implemented mature product module to access the mature product record.

4. The online publication system of claim 3, wherein the mature product records are accessible via a catalog.

5. The online publication system of claim 1, wherein the product module is to further receive a third version of the product record from the seller based on the first version not being accepted and to relate the product record to the second version.

6. The online publication system of claim 1, wherein the first version of the product record is accessible via a search query.

7. The online publication system of claim 1, wherein the first version of the product record comprises a first portion of product data retrieved from a product database and a second portion received from an author.

8. The online publication system of claim 1, wherein the sale item corresponds to both the first and the second version of the immature product record.

9. The online publication system of claim 8, wherein the second version is generated based on the first version.

10. The online publication system of claim 1, wherein the option to select the first version or the second version includes an option to rank the first version relative to the second version.

11. A method comprising:
receiving, at an online publication system, a listing indicating a sale item;
determining, at a catalog engine, that the sale item matches a product record;
providing a voting interface to a user, the voting interface comprising a first version of the product record, a second version of the product record, and an option to generate a third version of the product record;
receiving a selection of the first version of the product record; and
designating the first version of the product record as a completed product record based on a number of selections including the received selection.

12. The method of claim 11, further comprising adding the completed product record to a catalog.

13. The method of claim 11, further comprising determining a weight associated with the selection based on a history of the user.

14. The method of claim 11, further comprising:
receiving, at the online publication system, a query for the item for sale from a second user; and
providing at least the first version of the product record to the second user.

15. The method of claim 14, wherein the providing of at least the first version is based on at least one attribute of the product record, wherein the attribute is included in the second version of the product record and is not included in the first version of the product record.

16. The method of claim 11, wherein the designating of the first version of the product record as the completed product record is based on a total number of selections of the first version of the product record.

17. The method of claim 11, wherein the determining that the first version of the product record is the completed product record is based on a total number of selections of both the first version of the product record and the second version of the product record.

18. The method of claim 11, wherein the voting interface further comprises an option to generate a fourth version of the product record based on the first version of the product record.

19. A method comprising:
receiving a query for a sale item at an online publication system, the query comprising at least one attribute of the sale item; and
in response to the query, providing at least one completed product record corresponding to a first plurality of items for sale and at least one first version of a product record corresponding to a second plurality of items for sale.

20. A computer-readable storage medium having instructions embodied thereon executable by a processor, the instructions for performing a method comprising:
receiving, at an online publication system, a listing indicating a sale item;
determining, at a catalog engine, that the sale item matches a first version of a product record;
providing a voting interface to a user, the voting interface comprising a first version of the product record, a second version of the product record, and an option to generate a third version of the product record;
receiving a selection of the first version of the product record; and
determining that the first version of the product record is a completed product record based on a number of selections including the received selection.
